(19) United States
(12) Patent Application Publication
(10) Pub. No.: US 2023/0219504 A1
(43) Pub. Date: Jul. 13, 2023

(54) BICYCLE AND RACK SECURITY ATTACHMENT

(71) Applicant: Adam Simon, San Diego, CA (US)

(72) Inventor: Adam Simon, San Diego, CA (US)

(21) Appl. No.: 17/570,721

(22) Filed: Jan. 7, 2022

(51) Int. Cl. B60R 9/10

(52) U.S. Cl. CPC B60R 9/10

(57) ABSTRACT

An attachment locks a bicycle rack and/or a bicycle to a vehicle. The attachment may have a rigid body with a first end adapted to attach to a portion of the bicycle rack and/or a bicycle, and a second end adapted for insertion into a trunk or hatch space of the vehicle. The first end may include a loop, clasp or pivot joint which attaches to the bicycle or bicycle rack. The second end may be provided with an angle section joined to the rigid body via a radius. The second end is thin and flat, to allow the second end to extend into the trunk space and remain captured in the trunk space by a closed trunk lid, without interfering with operation of the trunk lid. An anchor may extend through or project outwardly from the second end, to resist attempts to pull the attachment out of the trunk space by force. A trunk bar has a loop section and ends adapted to be secured into a trunk space.

### BACKGROUND OF THE INVENTION

Bicycle theft affects millions of people. To better prevent theft, many bicycle locks have been proposed. Generally these are intended to lock a bicycle to an immovable object that is more difficult to cut through than the lock itself. Many bicycle locks can also be used to lock a bicycle to a bicycle rack on a vehicle. However, many types of bicycle racks are not easily or reliably secured to the vehicle. This allows a bicycle to be relatively easily stolen by simply removing the rack holding the bicycle from the vehicle.

There are three main types of bicycle racks: racks that attach to a vehicle’s trailer hitch (hitch racks); racks that attach to the trunk of the vehicle (trunk racks); and racks that attach to roof crossbars (roof racks). Hitch racks may be easily secured to the vehicle by locking the rack to the hitch, which is made of thick metal and is highly resistant to cutting. Bicycles can then be locked to the hitch rack which an appropriate bicycle lock. Trunk racks, on the other hand, are usually only secured to the vehicle by means of fabric straps or webbing. Locking a bicycle to a trunk rack is mostly useless at preventing theft because the straps can easily be cut or simply loosened and removed, allowing a thief to take the bicycle along with the rack. Some roof racks can be secured to the crossbars by a locking device. Other roof racks without a locking capability are susceptible to theft in a similar way to trunk racks.

### SUMMARY OF THE INVENTION

An attachment for securing a bicycle and/or a bicycle rack to a vehicle has a body with a first end adapted to attach to a portion of the bicycle or the bicycle rack, and a second end adapted for insertion into an interior of the vehicle. The first end may include a loop, clasp or pivot joint, or other connection, which attaches to the bicycle or bicycle rack. The second end may be provided with a radius and/or an angle section. The second end which extends into the vehicle is thin and flat, to largely avoid interfering with operation of the vehicle trunk lid, hatch lid, or rear door. An anchor may extend through and/or project outwardly from the second end, to provide additional resistance against attempts to pull out the attachment by force. The body may be a rigid element.

A bicycle rack may be provided with a theft resistant attachment that prevents removal of the bicycle rack from a closed and/or locked vehicle. A first end of the attachment is attached to a bar or tube of the bicycle rack. A second end of the attachment is adapted to be positioned in the interior space of a vehicle when the bicycle rack is installed on the vehicle. When the trunk lid, hatch lid, or rear door of the vehicle is closed, the second end cannot be removed, thus securing the bicycle rack to the vehicle.

A trunk bar for securing equipment to a vehicle includes first and second spaced apart arms joined to a loop section. Each of the first and second arms has a distal end adapted to be secured into a trunk space by a trunk lid of a vehicle. The distal end of each arm may have a rim radius and an angle section oriented at an angle to the arm. The loop section may be provided as a U-shaped bar. Each distal end may be a flat strip of metal or other material.

Other and further objects and advantages will become apparent to those skilled in the art from following detailed description and drawings, which are provided by way of example and are not intended to be taken as limits on the scope of the invention.

### BRIEF DESCRIPTION OF THE DRAWINGS

In the drawings, the same reference element number indicates the same element in each of the views.

FIG. 1 is a top and side perspective view of a first embodiment of the exterior section of a bicycle rack attachment securing a bicycle rack onto the trunk of a vehicle.

FIG. 2 is a bottom and side perspective view of the interior section of the rack attachment of FIG. 1.

FIG. 3 is a top and side perspective view of the rack attachment shown in FIGS. 1 and 2.

FIG. 4 is an end and bottom perspective view of the rack attachment of FIGS. 1-3.

FIG. 5 is a bottom view of a second embodiment of a rack attachment and/or a bicycle attachment.

FIG. 6 is a top and side perspective view of one interior section of the embodiment shown in FIG. 5.

FIG. 7 is a perspective view of a prior art bicycle rack mounted on a vehicle.

FIG. 8 is a side view of a third embodiment.

FIG. 9 is a partial side view of a fourth embodiment.

FIG. 10A is a partial rear view of a cross bar of bicycle rack of a fifth embodiment.

FIG. 10B is a top view of an attachment body having a T-end adapted to engage into the slot of the cross bar shown in FIG. 10A.

FIG. 11 is a side view of a sixth embodiment adapted to attach to a vertical member of a bicycle rack.

FIG. 12 is a schematic plan view of seventh embodiment.

FIG. 13 is a schematic side view of eight embodiment.

FIG. 14 is a schematic side view of ninth embodiment.

FIG. 15 is a top view of tenth embodiment.

### DETAILED DESCRIPTION OF THE DRAWINGS

Various embodiments of an attachment for securing a bicycle rack to a vehicle are disclosed. The present attachments are directed to securing trunk racks, i.e., racks for mounting on a trunk lid of a vehicle, and similar designs for mounting on a hatch lid of a hatch back vehicle, or on the rear door an SUV, van or minivan. For purpose of description, all of these types of bicycle racks are collectively referred to here as trunk racks. Thus, reference below to trunk, trunk lid, trunk seal, etc. refer as well to equivalent or similar elements in hatch back vehicles, SUV’s, vans and minivans. Accordingly, as used here and in the claims, the term trunk space or interior space includes the space of the trunk of a sedan, the hatch space of a hatch back vehicle, and the rear space of an SUV, van or minivan. Correspondingly, the terms trunk lid includes a hatch lid and a rear door.

The principles of the invention may also be applied to other types of bicycle racks as well, such as spare tire racks and/or roof racks. The principles of the invention may additionally be used for cargo containers, sports equipment racks, and similar apparatus used on vehicles.

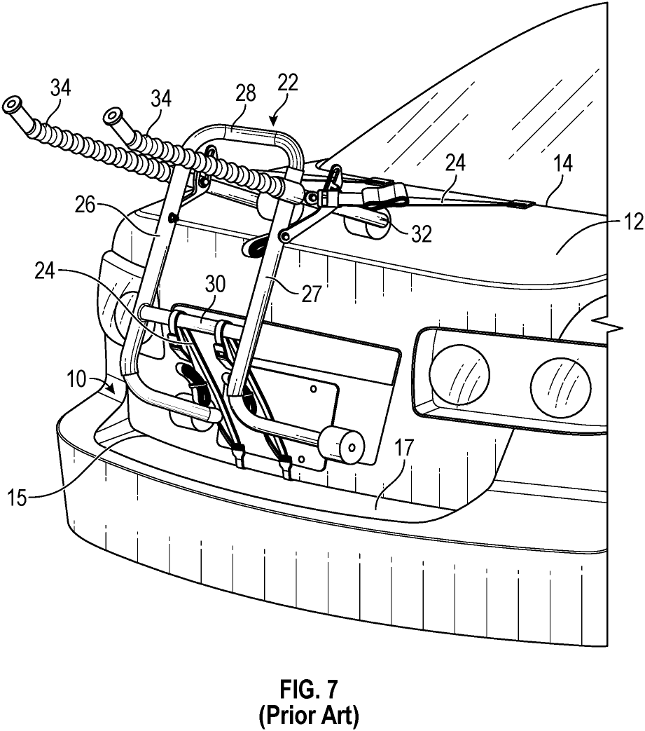

FIG. 7 shows one example of a prior art trunk bicycle rack 22 which the present attachment can secure to a vehicle 10. The bicycle rack 22 is mounted on the trunk lid 12 of the vehicle 10. In the example shown, the bicycle rack 22 has a load frame 32 pivotally attached to a rack frame 26. The rack frame 26 has an upper cross bar 28 and a lower cross bar 30 each joined to left and right vertical risers 27. The load frame 32, in the example shown, is a U-shaped component having foam rollers which rest on the trunk lid 12, and a pair of load frame arms 34, on which bicycles may be mounted. Straps 24 on the bicycle rack 22 have hooks which hook onto the trunk lid lip 15 and the trunk lid rim 14. The bicycle rack 22 of the type shown in FIG. 7, and similar designs, are widely used. Although bicycles held on the bicycle rack 22 can be locked onto the bicycle rack 22 using various chain, U-bar or cable types of locks, the bicycle rack itself can be easily removed from the vehicle by cutting or loosening the straps 24. The bicycles and the bicycle rack 22 are therefore easily stolen. Similar types of bicycle and cargo racks applicable to the invention are attached in similar ways onto a hatch lid or rear door of a hatch back, SUV, van or minivan type of vehicle.

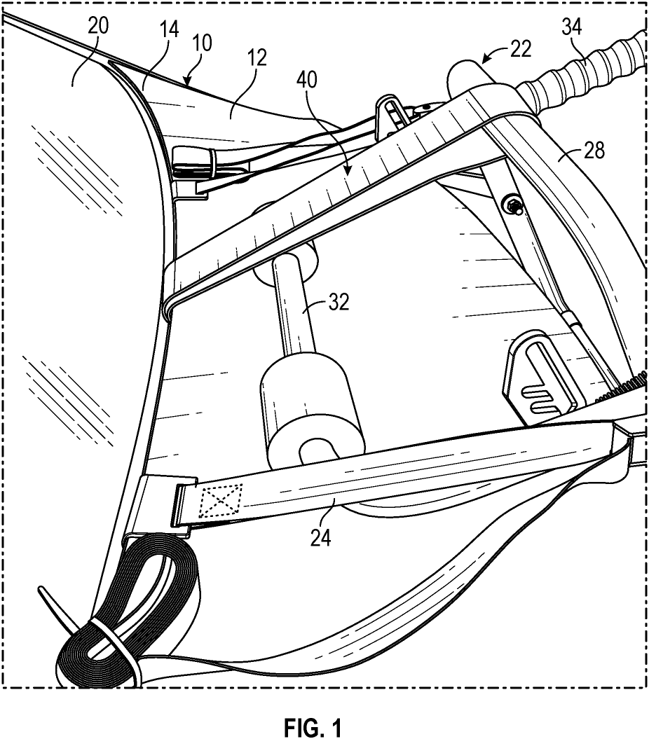

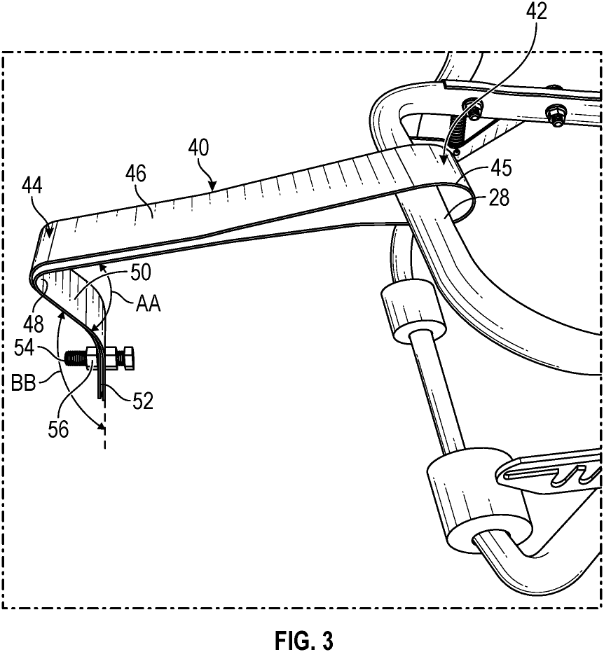

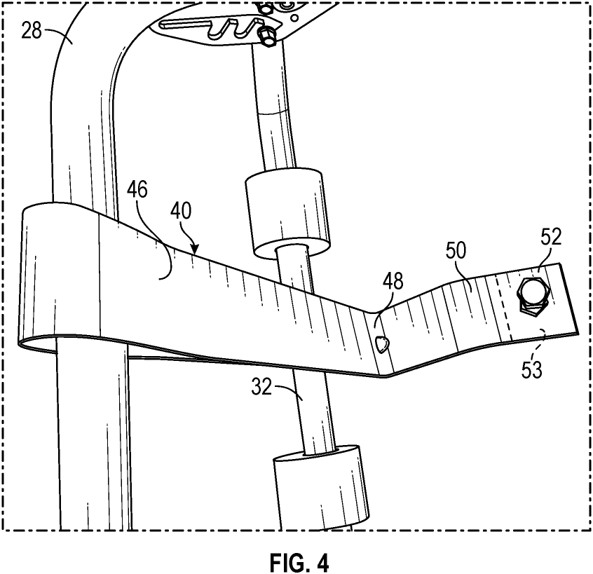

Turning to FIGS. 1-4, an attachment 40 may be provided as an aftermarket accessory, or built into or onto a bicycle rack, to prevent theft of the bicycle rack 22, and the bicycles on the bicycle rack 22. The attachment 40 has a first or frame end 42, a body 46, and a second or trunk end 44. As best shown in FIG. 3, the second end 44 may have an angle section 50 joined to a straight section of the body by a rim radius 48. The angle section 50, if used, may form an angle AA 30 º to 80 º to the straight section. The free end of the angle section 50 may provide an anchor section 52.

The body may be rigid. As used here the term rigid means not perceptibly flexible or deformable in the length and width axes, in ordinary use. For example, in use the present rigid body if provided in the form of flat strip of material does not exhibit perceptible bending or deformation in the direction of its length or width. The term rigid does not necessary exclude perceptible bending or deflection in the direction of the thickness of the rigid body, i.e., the direction of the arrow 40 in FIG. 3. In some embodiments the body 46 may not be rigid.

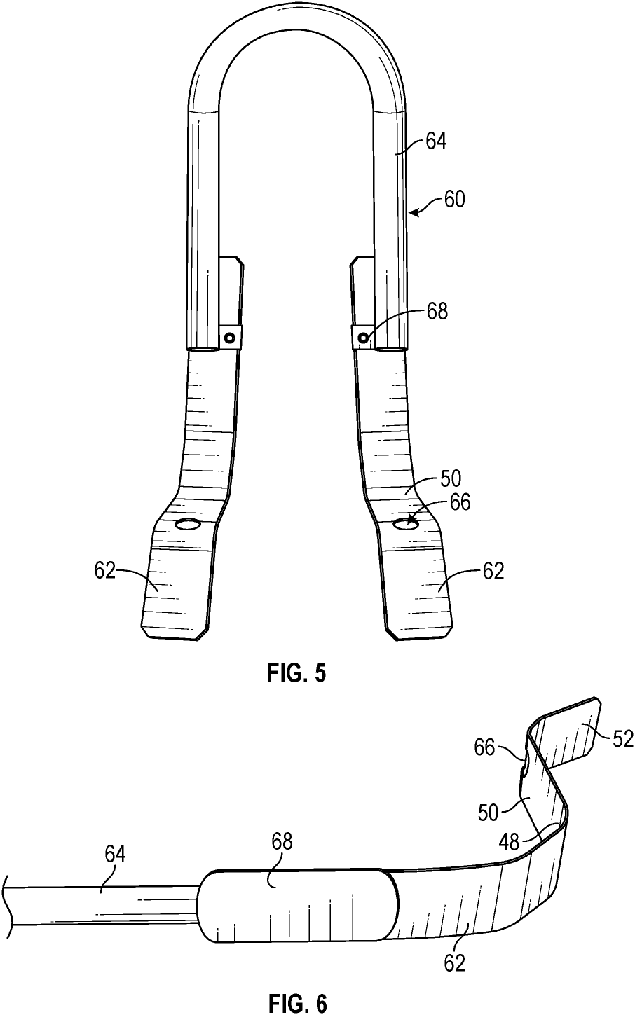

The first end 42 is attached to or around a portion (the upper cross bar 28 in this case) of the bicycle rack 22. Specifically, in the example of FIGS. 1-4, the attachment is provided as an elongated strip of material, which is folded over on itself creating a loop section 45 which loops around the upper cross bar 28. In this embodiment, the attachment 40 may be provided as a single piece of material. The ends of the elongated strip overlay each other. An anchor 54, such as a threaded bolt passing through the anchor section 52, if used, may extend through a bolt hole 66 (shown in FIG. 5) and hold the ends of the elongated strip together. The anchor section 52 may form an angle BB with the angle section 50.

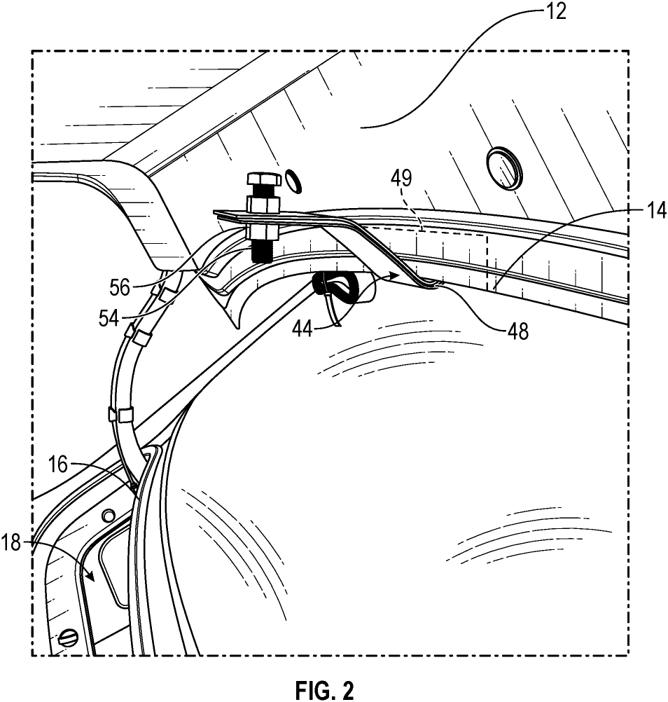

Referring to FIG. 2, in the example shown, the attachment 40 is provided as a strip of 12 gauge steel (2-3 mm thick). The double layer of 12 gauge steel at the second end of the attachment as shown in FIG. 2 is then 4-6 mm thick. The rim radius 48 extends around the trunk lid rim 14, with the second end 44 projecting into the trunk space 18, when the trunk lid 12 is closed. The rim radius 48 may be 6 to 24 or 30 mm (0.1 to 1 or 1.25 inches). With the attachment 40 positioned as shown in FIGS. 1 and 2, the trunk seal 16 compresses to provide clearance for the second end 44. Referring back to FIG. 1, with the attachment 40 installed as described, and with the trunk lid 12 in the down and locked position, the bicycle rack 22 cannot be removed from the vehicle 10. In some embodiments, the angle section 50 and the anchor section 52 may be omitted, with the attachment 40 using a rim radius 48 alone to secure the attachment to the trunk lid. Alternatively, the attachment may be provided with a second end having only an angle section 50 and with no rim radius 48, or a very small rim radius 48.

The attachment is resistant to cutting due to the thickness, hardness and strength of the material forming the attachment, such as steel and similar metals, or cut-resistant fiber and/or matrix materials. The attachment 40, or at least the exposed body and the first end 42, may be 36 mm to 125 mm (0.5 to 5 inches) wide, or 50 to 100 mm (2 to 4 inches) wide. This makes attempts to saw or cut through the attachment 40 more time consuming and difficult. The width of the attachment 40 is also hinders cutting using bolt cutters because the width of the attachment may be made greater than the jaw length of typical bolt cutters.

Referring still to FIG. 2, the second end 44 fits around the trunk lid rim 14. This prevents the attachment 40 from being pulled out or off of the vehicle using direct force. In most designs, the thickness and stiffness of the attachment material alone can prevent the rim radius 48 from straightening out sufficiently to allow the second end to be pulled out of the trunk space 18, even if high force is applied. In many or most vehicles, the trunk lid 12 will yield before the attachment 40 can be forcibly pulled out. The anchor 54 may be used to provide additional resistance against attempts to forcibly pull the second end 44 of the attachment out of the trunk space 18. In designs using thinner material for the attachment, the anchor 54 may provide the primary resistance. As shown in FIG. 2, the anchor 54 may be a bolt extending perpendicularly through the second end 44, with one or more nuts 56 holding the bolt in place.

In many vehicles, with the trunk lid 12 up as shown in FIG. 2, there is sufficient clearance between the rear glass 20 and the trunk lid rim 14 to move the second end 44, including the anchor 54, into the trunk space 18. In other cases, the anchor 54, if used, may be temporarily removed from the attachment 40, the second end 44 inserted into the trunk space 18, and the anchor 54 then reinstalled onto the second end 44. The end(s) of the attachment that extend into the trunk space may be sufficiently flat and thin so that they do not interfere with operation of the trunk or the trunk seal. Generally the end(s) may be about 0.8 to 7 mm (0.03 to 0.28 inches) or 1.0 to 4.0 mm (0.04 to 0.16 inches) thick.

The anchor 54 may alternatively be provided as a tab, lever, wingnut or plate 53 on a quarter-turn rotation or screw thread fitting. The plate 53 is aligned with the second end 44 to allow the second end to be inserted into the trunk space 18, and is then rotated one quarter-turn to provide an anchor. The rotation fitting may have a friction or detent element to prevent inadvertent counter-rotation of the plate 53. The second end of the attachment may optionally be located in an alternative space if necessary, such as the passenger compartment, via a slightly open window or sun or moon roof, instead of the trunk space 18.

Referring to FIGS. 1 and 7, the attachment 40 may alternatively be attached to, or extend from, a lower cross bar 30 with the second end 44 positioned in the trunk space 18, between the trunk lid lip 15 and bumper or body 17 of the vehicle. Referring once again to FIG. 2, a reinforcing plate 49 may be attached (e.g., adhered or riveted) to the underside of the trunk lid 12 to prevent or reduce damage to the trunk lid resulting from attempts to pull out the attachment using force.

FIGS. 5 and 6 show a trunk bar 60 having second ends 62 permanently attached, e.g., via a weldment 68, to arms 64. The trunk bar 60 may be a U-shaped round metal bar having a covering or coating of soft material such as rubber, vinyl, etc. Referring to FIG. 6, the second ends 62 may have the same configuration as the second end 44 in the embodiment 40 of FIGS. 1-4. The second ends 62 are advantageously parallel to the arms 64 of the trunk bar 60, and are permanently spaced apart by a fixed distance (determined by the radius of curvature of the trunk bar 60). Alternatively the trunk bar 60 may be manufactured as a single piece. While shown as having a U shape, the trunk bar 60 may be provided in other shapes as well

In use to secure a bicycle rack to a vehicle, the trunk bar 60 is placed around a generally vertical portion of the bicycle rack, with the trunk bar 60 oriented in a horizontal plane. The second ends 62 are positioned into the trunk space 18, in the same way as with the attachment 40 and the trunk lid is closed. The bicycle rack is then secured to the stationary vehicle. Anchors may be used with the trunk bar 60 in the same way as with the attachment 40 described above.

The trunk bar 60 may also be used to secure a bicycle directly to a stationary vehicle without using a bicycle rack or a separate bicycle lock. In this case the trunk bar 60 is placed around a part of the bicycle, e.g., the seat tube or the head tube, and the second ends 62 are positioned into the trunk space 18. With the trunk lid closed the bicycle is secured to the stationary vehicle, without using a bike rack or a separate bicycle lock. The trunk bar 60 may be similarly used to secure other equipment to a stationary vehicle. Depending on the equipment to be secured, the arms 64 and/or the second ends 62 of the trunk bar 60 may optionally have a one-quarter turn twist so that the loop section at the first end of the trunk bar 60 is in a vertical plane instead of a horizontal plane.

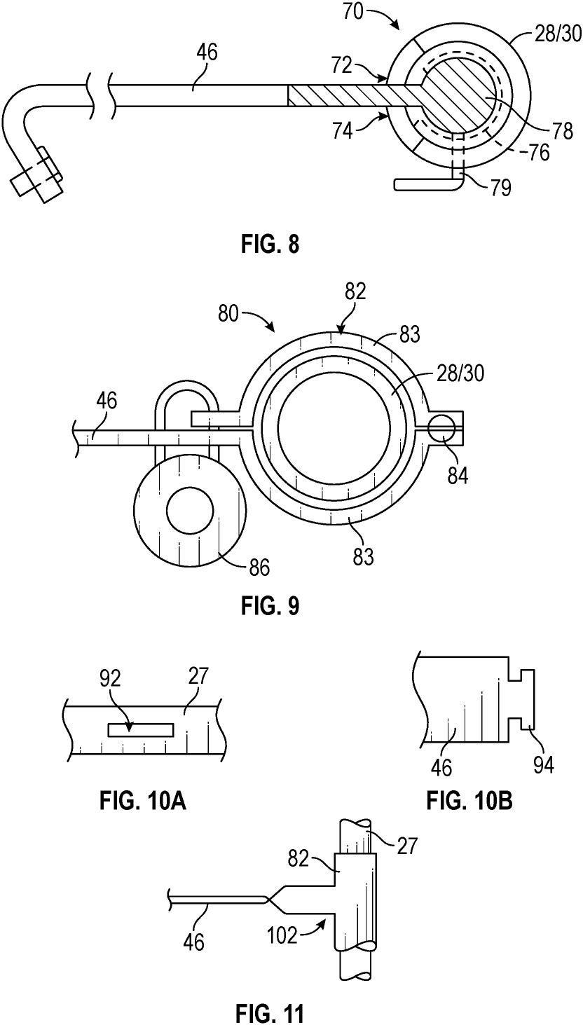

FIG. 8 shows a bicycle rack having an integral attachment 70. In other words, the attachment 70 is built into or onto the bicycle rack during the manufacture of the bicycle rack, with the attachment not necessarily removable from the bicycle rack. The body or center section 46 and the second end 44 of the attachment 70 may be the same as the attachment 40. The first end of the attachment 70 is attached to the bicycle rack, specifically, to the upper cross bar 28 or lower cross bar 30, optionally via a pivot joint 72. Various pivot joints 72 may be used. FIG. 8 shows the attachment 70 having a first end extending through a slot or window 74 in the cross bar and joined to ball or tube segment 78 pivotally captive within the cross bar 28 or 30. The pivot joint 72 allows the vertical axis angle between the attachment 70 and the bicycle rack to vary, as may be needed to mount the bicycle rack on various vehicles. Portions of the bicycle rack may be reinforced to better resist attempts to pull the attachment out of the bicycle rack.

The term pivotally attached as used here means pivotal at least while being installed, and includes attachments that are initially pivotal and subsequently made non-pivotal.

A spring 76 may be provided in or on the cross bar to apply a constant downward force on the body 46. A locking mechanism 79 may also be provided to lock the pivot joint 72 in a fixed position. If used, the locking mechanism 79 is unlocked while the bicycle rack is being installed, to allow angular movement between the bicycle rack and the body 46. The locking mechanism 79 is then engaged or locked after installation is complete.

FIG. 9 shows a fourth embodiment wherein a clasp or tube fitting 82 is provided on the first end of the attachment 80. The clasp 82 may include complimentary semi-circle tube segments 83 adapted to fit around or clamp onto a portion of the bicycle rack (a horizontal cross bar 28 or 30 in the example shown). On the back side (towards the back of the vehicle) the tube segments 83 may be attached to each other by a hinge or spring 84. On the front side, the tube segments may be secured or locked together using a padlock 86 or similar locking mechanism. The body 46 and second end 44 may be the same as the attachment 40. Using the embodiment of FIG. 9, some types of bicycle racks may be removed from the vehicle without opening the trunk lid, and with the attachment 80 remaining in or on the vehicle after the bicycle rack is removed. Thus, this embodiment allows some bicycle racks to be installed on or removed from a vehicle without having a key for the vehicle, or access to the trunk, hatch or rear door of the vehicle.

FIGS. 10A, 10B and 11 show the concepts described above relative to attaching to a horizontal portion of a bicycle rack (e.g., cross bars 28 and 30) may also be used to attach to a vertical portion of a bicycle rack. In FIG. 10A a vertical slot 92 is cut into a vertical portion of a bicycle rack, such as a riser 27. The first end 42 of an attachment has a T-shaped fitting 94 as shown in FIG. 10B,which may be inserted into the vertical slot 92. The attachment is then rotated ¼ turn into a horizontal orientation. The second end 44 is then positioned in the trunk space 18 as described above. FIG. 11 shows an alternative design 102 where the body 46 has a one-quarter turn or twist segment 104 to allow attachments described above to attach to a vertical portion of a bicycle rack.

As an alternative for attaching to a vertical portion of a bicycle rack, the second end 44 of the attachment 40 may be provided with a one-quarter turn or twist segment 104. In this case the attachment is rotated one-quarter turn as it is inserted into the trunk space, with the loop section 45 (or other connection element) rotating from horizontal to vertical after installation of the attachment is complete.

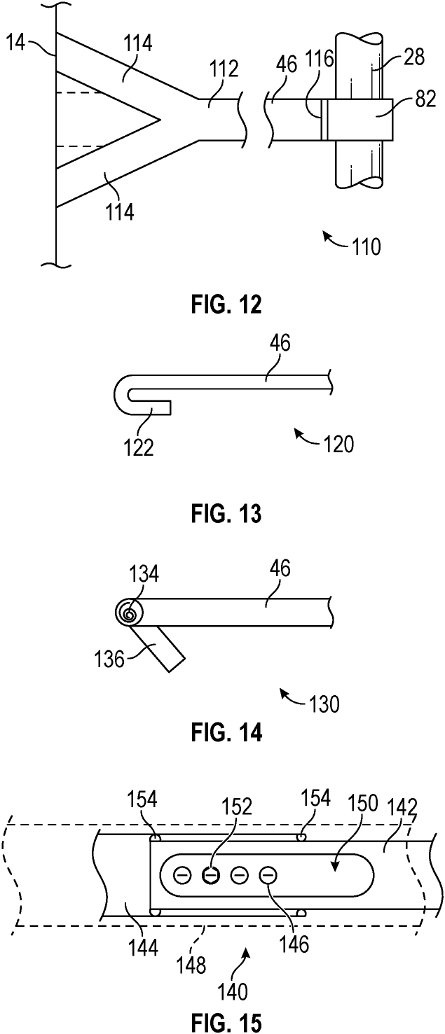

FIG. 12 shows an embodiment 110 where the body 46 is split into first and second legs 114 in a Y-shaped configuration. This embodiment has two spaced apart second ends. As shown in dotted lines in FIG. 12, the legs 114 may be used in addition to the single second end 44 of the embodiment 40. FIG. 12 also shows an optionally lockable hinge or ball joint 116 which may be provided between the attachment and the bicycle rack, in any of the embodiments described.

FIG. 13 shows an alternative second end 120 having a hook 122, without any of the elements of the second end 44 shown in FIGS. 1-4. This embodiment may be advantageous for an attachment designed to fit on a specific vehicle. In this case, the hook 122 is sized and shaped complimentary to the trunk lid rim 14 of the specific vehicle.

FIG. 14 shows another alternative second end 130 having an arm 136 forced by a spring 134 in a counter clockwise direction, to engage the underside of the trunk lid 12 after the attachment is installed.

The attachments may be provided in varying lengths to account for differences in the shapes and dimensions of vehicles and bicycle racks. The attachments may also be provided with an adjustable length body 140, as shown in FIG. 15. In this embodiment, the fixed length body 46 of embodiments described above is replaced with a top segment 142 overlying a bottom segment 144. The top segment 142 can slide over the bottom segment 144. The overlapping portions of the segments may be enclosed within a protective sleeve or cover 148. An array of spaced apart adjusting holes 146 are provided in the overlapping portions. In use, the overlapping segments are telescopically moved towards or away from each other to achieve a desired length. A pin 152 is then inserted into the selected adjusting holes 146. A slot 150 in the sleeve 148 allows access to the adjusting holes 146. Stops 154 prevent separating the segments so that the attachment stays attached to the bicycle rack even if the pin 152 is removed. A ratcheting mechanism having a lever or knob may be used instead of the adjusting holes 146 and the pin 152. The segments 142 and 144 may be flat overlapping plates, or they may be telescopically slidable tube sections.

Elements described as vertical or horizontal include elements that are near vertical and near horizontal, that is within 30° of vertical and horizontal. Each of the features of the various embodiments described above may be combined, or used separately, as desired. The rigid body embodiments described above are more resistant to cutting relative to many existing cable or chain locks. However, in another alternative embodiment, the body 46 may be provided as a cable or a chain, of suitable size. For example, the attachment 40 may be modified by replacing the rigid body 46 with a cable or a chain attached to the second end 44 having one or more of the configurations and elements described above.

Methods may include placing a loop section of an attachment around a part of a bicycle, bicycle rack, or other equipment, and securing the attachment to a vehicle by placing an end or ends of the attachment into a trunk space and closing a trunk lid.

Thus, novel bicycle or equipment racks, rack attachments and securing devices have been shown and described. Various changes and substitutions may of course be made without departing from the spirit and scope of the invention. The invention, therefore, should not be limited, except by the following claims and their equivalents.

1. An attachment for securing a rack to a vehicle, comprising:
a body having a first end adapted to attach to a part of the rack; and
the body having a second end adapted for insertion into and retention in an interior space of the vehicle.

2. The attachment of claim 1 wherein the first end comprises loop section which attaches to the part of the rack by looping around the part.

3. The attachment of claim 1 wherein the first end is permanently attached to the part of the rack via a pivot joint.

4. The attachment of claim 2 wherein the body comprises a flat strip of material folded over on itself.

5. The attachment of claim 1 wherein the second end includes an angle section joined to the body via a radius.

6. The attachment of claim 1 wherein the second end has a flat segment with a thickness of 1 to 7 mm, to allow the second end to extend into the interior space and held in the interior space by a closed lid or door.

7. The attachment of claim 6 wherein the body is rigid, further including an anchor on the flat segment for preventing removal of the second end from the interior space by force.

8. A trunk bar for securing equipment to a vehicle, comprising:
first and second spaced apart arms joined to a loop section;
each of the first and second arms having a distal end adapted to be secured into a trunk space by a trunk lid of a vehicle.

9. The trunk bar of claim 8 wherein the distal end of each arm has a rim radius and an angle section oriented at an angle to the arm.

10. The trunk bar of claim 8 wherein the loop section comprises a U-shaped bar and each distal end comprises a flat strip of metal.

11. The trunk bar of claim 8 further comprising an anchor attached to each distal end.

12. A bicycle rack, comprising:
at least one frame having a bar;
a rigid body having a first end attached to the bar, the rigid body having a second end adapted to be positioned in the trunk of a vehicle when the bicycle rack is installed on the vehicle, to prevent removal of bicycle rack from the vehicle when the vehicle is closed.

13. The bicycle rack of claim 12 having a load frame and a rack frame pivotally attached to the load frame, wherein the bar is a horizontal cross bar of the rack frame.

14. The bicycle rack of claim 12 wherein the first end of the rigid body is pivotally attached to the horizontal cross bar.

15. The bicycle rack of claim 12 wherein at least a portion of the second end is adapted to extend in between a lip of the trunk lid and a bumper or body of the vehicle.

16. The bicycle rack of claim 12 wherein the second end has a thickness of 1-7 mm to allow the second end to positioned between a trunk lid and a trunk seal of the vehicle.

17. The bicycle rack of claim 12 wherein the rigid body has an adjustable length.
